(19) United States
(12) Patent Application Publication
(10) Pub. No.: US 2011/0314245 A1
(43) Pub. Date: Dec. 22, 2011

(54) SECURE MEDIA SYSTEM

(76) Inventors: Matthew D. Hanes, Fort Collins, CO (US); Binh Truong, Sunnyvale, CA (US)

(21) Appl. No.: 13/148,492

(22) PCT Filed: Feb. 9, 2009
(86) PCT No.: PCT/US09/33565

§ 371 Date: Aug. 9, 2011

(51) Int. Cl. G06F 12/14

(52) U.S. Cl. 711/164; 711/E12.094

(57) ABSTRACT

In one embodiment a network attached storage device comprises at least one storage media, a detection module to detect a connection of a media source to the network attached storage device, a network interface to receive, in the network attached storage device, an activation key associated with the media source, an activation module to determine whether the activation key is stored in a computer-readable memory coupled to the network attached storage device, and in response to a determination that the activation key is not stored in a computer-readable memory coupled to the network attached storage device, to associate the activation key with a device identifier for the network attached storage device and to store the activation key and the device identifier in the computer-readable memory coupled to the network attached storage device, an imaging module to create an image of at least a portion of the media content on the media source in a computer-readable memory coupled to the network attached storage device, and a security module binding the image of the media content to the network attached storage device.

### BACKGROUND

Network Attached Storage (NAS) refers to a dedicated data storage device(s) connected directly to a computer network to provide centralized data access and storage services to one or more network clients such as, e.g., a personal computer. NAS devices are being used as media servers to store media files such as, e.g., music and video files. In some circumstances it may be useful to provide users of NAS devices with the ability to securely load protected media content to a NAS device.

### BRIEF DESCRIPTION OF THE DRAWINGS

FIG. 1 is a schematic illustration of one embodiment of network attached storage environment in which a secure media system may be implemented.

FIG. 2 is a schematic illustration of an embodiment of a network attached storage device adapted to implement a secure media system.

FIG. 3 is a flowchart illustrating operations in one embodiment of a method to implement a secure media system in network attached storage.

FIG. 4 is a flowchart illustrating operations in one embodiment of a method to implement a secure media system in network attached storage.

FIG. 5 is a flowchart illustrating operations in one embodiment of a method to implement a secure media system in network attached storage.

### DETAILED DESCRIPTION

Described herein are exemplary secure media systems and associated methods which may be implemented in network attached storage. The methods described herein may be embodied as logic instructions stored on a computer-readable medium. When executed on a processor, the logic instructions cause a general processor to be programmed as a special-purpose machine that implements the described methods. The processor, when configured by the logic instructions to execute the methods recited herein, constitutes structure for performing the described methods.

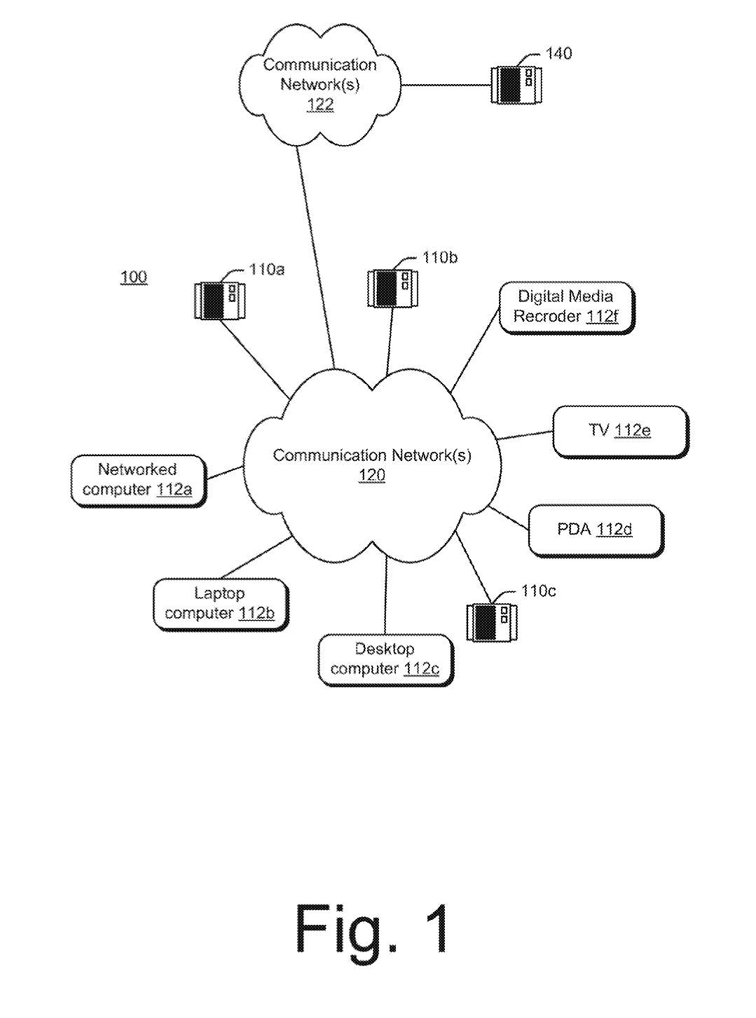

FIG. 1 is a schematic illustration of one embodiment of network attached storage environment in which a secure media system may be implemented. Environment 100 may comprise one or more network attached storage devices 110a, 110b, 110c connected to one or more network clients 112a, 112b, 112c, 112d, 112e, 112f by a communication network 120. Further, network attached storage devices 110a, 110b may be connected to a remote server 140 via a communication network 122.

Network attached storage devices 110a, 110b, 110c may be implemented as one or more communicatively connected storage devices. Exemplary storage devices may comprise, but are not limited to, the Media Vault™ line of storage devices commercially available form Hewlett-Packard Corporation of Palo Alto, Calif., USA. In some embodiments, at least a portion of communication network 120 may be implemented as a private, dedicated network such as, e.g., a local area network (LAN) or a wide area network (WAN). Alternatively, portions of communication network 120 may be implemented using public communication networks such as, e.g., the Internet, pursuant to a suitable communication protocol such as, e.g. TCP/IP.

Network clients 112a, 112b, 112c, 112d, 112e, 112f may be implemented as computing devices such as, e.g., a networked computer 112a, a laptop computer 112b, a desktop computer 112c, a personal digital assistant (PDA) 112d, a smart phone 112e, other computing devices 112f or the like. Applications running on network clients 112a, 112b, 112c, 112d, 112e, 112f may initiate file access requests to access information stored in network attached storage devices 110a, 110b, 110c. Network attached storage devices 110a, 110b, 110c receive file access requests and, in response, locate and return the requested information to the network client that originated the request.

In some embodiments, a network attached storage device such as device 110a or 110b may function as a media server. Media files such as, for example, music or video files, may be stored on the network attached storage device. One or more of client devices 112a, 112b, 112c, 112d, 112e, 112f, may initiate a request for media content from a network attached storage device. In response, the network attached storage device can either transmit a copy of the media file to the requesting client or may initiate a playback routine to play the media file to the requesting client device. In such embodiments, users of the network attached storage device may choose to load copyrighted works from a storage media (e.g., a compact disc, a digital video disc, or the like) onto the network attached storage device.

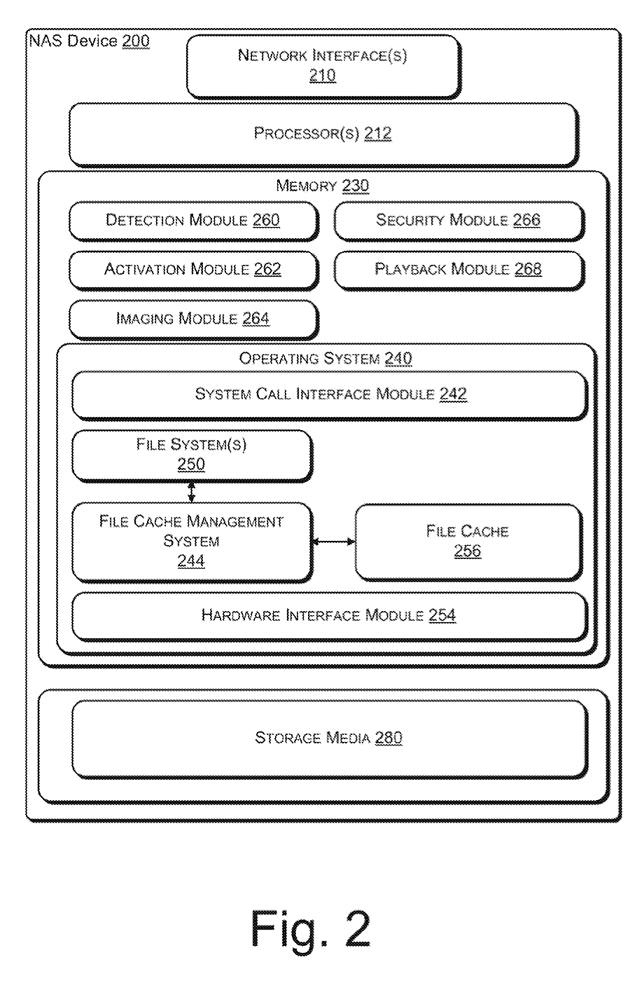

FIG. 2 is a schematic illustration of an embodiment of a network attached storage device adapted to implement a secure media system. The system depicted in FIG. 2 may be used to implement one or more of network attached storage devices 110a, 110b, 110c depicted in FIG. 1. Referring to FIG. 2, network storage device 200 comprises one or more network interfaces 210 which enables a communication connection with a network such as, e.g., network 120.

Network interface 210 may comprise an input/output (I/O) port to provide a physical connection with a network. For example, network interface 210 may comprise an Ethernet port. Network interface 210 may comprise a network interface card (NIC), also commonly referred to as a network adapter or a network card. The NIC manages I/O operations to enable NAS device 200 to communicate over a network. Alternatively, the operations of the NIC may be implemented on a main circuit board such as, e.g., a motherboard of NAS device 200.

NAS device 200 further comprises at least one processor 212. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

NAS device 200 further comprises system random access memory and/or read-only memory 230. Memory 230 comprises an operating system 240 for managing operations of NAS device 200. In one embodiment, operating system 240 comprises a hardware interface module 254 that provides an interface to system hardware. The particular embodiment of operating system 240 is not critical to the subject matter described herein. Operating system 240 may be embodied as a UNIX operating system or any derivative thereof (e.g., Linux, Solaris, etc.) or as a Windows® brand operating system.

Operating system 240 comprises (or interfaces with) a file system(s) 250 that manages files used in the operation of NAS device 200. For example, file system(s) 250 may implement one or more file systems such as FAT, NTFS, ext3, reiser, or the like. In one embodiment, operating system 240 may comprise a file cache management system 244 interposed logically between the file system(s) 250 and underlying modules such as, e.g., the hardware interface module 254. File cache management system 244 interfaces with the file system(s) 250 to manage the file cache 256 as a resource that may be shared between users of the computer system, e.g., on a per-workload basis.

Operating system 240 further comprises a system call interface module 242 that provides an interface between the operating system 240 and one or more application modules that execute on NAS device 200.

NAS device 200 further comprises storage media 280. For example, storage media 280 may be embodied as one or more arrays of magnetic disk drives, solid state drives or the like. Alternatively, storage media 280 may comprise optical, magneto-optical, or electro-optical storage media. Storage media 280 may be configured to implement RAID redundancy.

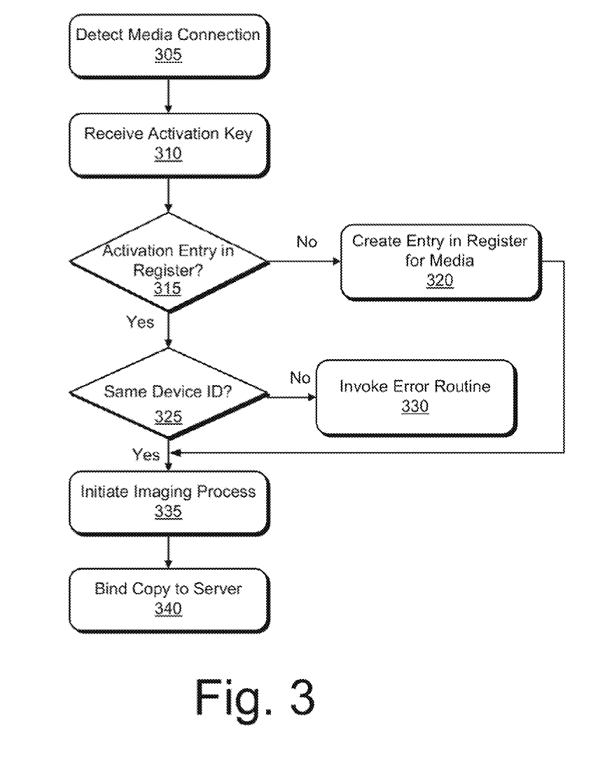

NAS device 200 further comprises a detection module 260, an activation module 262, an imaging module 264, a security module 266, and a playback module 268. In some embodiments, these modules are embodied as a software module that executes on processor(s) 212. Additional details about these modules and their functionality is described below with reference to FIGS. 3-5.

FIG. 3 is a flowchart illustrating operations in one embodiment of a method to implement a secure media system in network attached storage. In some embodiments, the operations depicted in FIG. 3 are implemented by one or more of the modules 260-268.

Referring to FIG. 3, at operation 305, the detection module 260 in a network attached storage device detects the connection of a media source to the network attached storage device. In some embodiments, detecting the connection of a media source to the network attached storage device comprises detecting the insertion of a media source into a computing device coupled to the network attached storage device. For example, in some embodiments, one or more of the computing devices 112a-112f may generate a signal in response to the insertion of a media source such as a CD or a DVD into a drive of the computing device. Alternatively, one or more of the computing devices 112a-112f may generate a signal to indicate that a user wishes to upload media content from the computing device to the NAS device 200. Alternatively, a media source may be loaded directly into a drive on the NAS device 200.

At operation 310 the NAS device 200 receives an activation key associated with the media source. In some embodiments the activation key may be embodied as an alphanumeric code that is received in combination with the signal notifying the NAS device 200 of the connection of the media source. By way of example, a media source such as a CD or a DVD may be distributed with an activation key encoded in the media. In alternate embodiments, the media source may lack an activation key encoded in the media. In such embodiments, a registration process to obtain an activation key may be initiated either at the client device or at the NAS device 200. For example, a request for an activation key may be initiated to a remote server 140. The request may include a unique identifier associated with the media source. Remote server 140 may maintain a list of activation keys. In response to the request, remote server 140 may transmit an activation key for the media source to the requesting device. In addition, the remote server 140 may store the unique identifier associated with the media source in a memory module in association with the activation key in an activation registry.

At operation 315, it is determined whether there is an activation entry for the media source in an activation registry. In some embodiments, the activation registry may be managed by remote server 140 and may store a unique identifier associated with a media source in association with an activation key. The activation registry may be embodied as a flat file or as a database. In some embodiments, the activation module 262 launches an activation inquiry to the remote server 140. The inquiry may include the activation key associated with the media source and the unique identifier associated with the media source. In response to the inquiry, the remote server 140 checks the activation registry to determine whether the media source is available for activation. In some embodiments a media source may be activated on only a limited number of devices at any particular time. For example, a media source may be restricted to activation on a single server at any time.

If, at operation 315, there is no activation entry for the media source in the activation registry, which indicates that the media source has not been activated on another server, then at operation 320 the remote server 140 creates an entry in the activation register for the media source and stores the unique identifier associated with the media source and the activation key in the activation registry. Further, in some embodiments the activation request may comprise a unique identifier associated with the NAS device 200, which may also be stored in the activation registry. This indicates that the media source has been activated. Control then passes to operation 335, discussed below.

By contrast, if at operation 315 there is an activation entry associated with the activation code for the media source, then control passes to operation 325. At operation 325 it is determined whether the activation key is associated with the same device identifier associated with the NAS device 200. If the activation key is associated with a different device identifier, then control passes to operation 330 and an error routine is invoked. For example, the error routine may include displaying an error message on a user interface coupled to the NAS device, e.g., on one of the client devices 112a-112f.

By contrast, if the device ID in the activation registry is the same as the device ID associated with the NAS device 200, then control passes to operation 335 an the imaging module 264 initiates an imaging process to image at least a portion of the media content from the media source to the NAS device 200. In embodiments in which the media source is encoded as a DVD, the imaging process creates a complete copy of the ISO image of the media content on the DVD.

At operation 340 the image is bound to the server. For example, the image may be encrypted using an encryption key derived from at least one of the activation key or a unique identifier associated with the NAS device 200, or both. In some embodiments, the image may be encrypted using the server MAC address or any other unique hardware identifier associated with the NAS device 200.

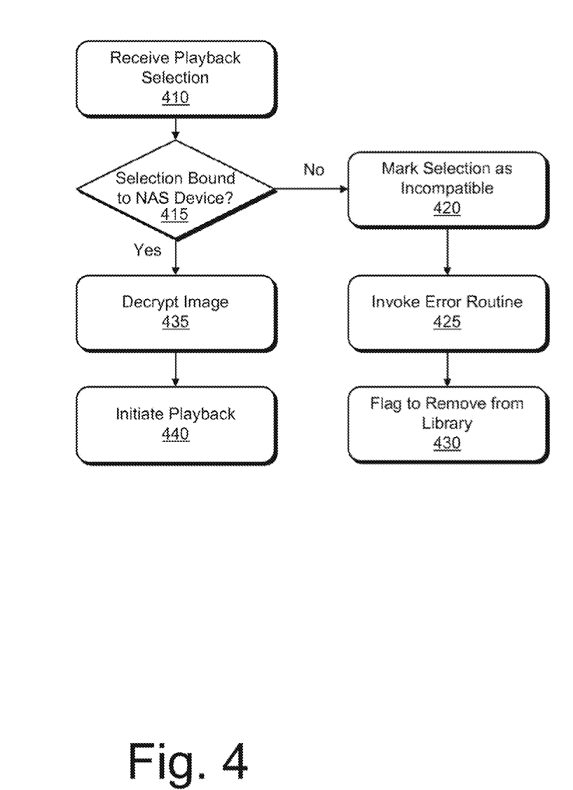

Once the image is stored on the NAS device one or more of the clients 112a-112f may request that the media content be played back. FIG. 4 is a flowchart illustrating operations in one embodiment of a method to implement a secure media system in network attached storage. Referring to FIG. 4, at operation 410 the NAS device 200 receives a playback selection from a client device.

At operation 415 it is determined whether the selection in the request is bound to the NAS device. In one embodiment, the NAS device launches an inquiry to the remote server 140 to request the remote server 140 to check the activation register to determine whether the activation key is associated with the device ID for the NAS device in the activation register. If the activation key is not associated with the device ID for the NAS device, then the selection is considered not to be bound to the NAS device. By contrast, if the activation key is associated with the device ID for the NAS device, then the selection is considered to be bound to the NAS device

In another embodiment, the NAS device may initiate a decryption process for a portion of the media selection using the same encryption key which the NAS device 200 uses to encrypt data. If the encryption is unsuccessful, then the selection is considered not to be bound to the NAS device. By contrast, if the encryption is successful, then the selection is considered to be bound to the NAS device.

If, at operation 415, the selection is not bond to the NAS device, then control passes to operation 420 and the selected media is marked as being incompatible in the media library of the NAS device 200. Control then passes to operation 425 and an error routine is invoked. In some embodiments, the error routine may include displaying an error message on a user interface coupled to the NAS device, e.g., on one of the client devices 112a-112f. At operation 430 the media selection is flagged for removal from the media library on NAS device 200. Subsequently, the media selection may be removed from the media library on the NAS device 200.

By contrast, if at operation 415 the selection is bound to the NAS device 200, then control passes to operation 435 and the image is decrypted. At 440 the playback module 268 initiates playback of the media selection on the NAS device 200.

Thus, the operations of FIG. 4 enable NAS device 200 to play back a video file in response to an inquiry from a client computing device coupled to the NAS device 200. In another embodiment, the NAS device 200 may be adapted to generate Universal Plug and Play (UPnP) metadata (e.g., title of video, length of video, etc.) for the media in the NAS device 200 such that a digital media adapter (DMA) or other UPnP device can locate and stream content from the NAS device 200.

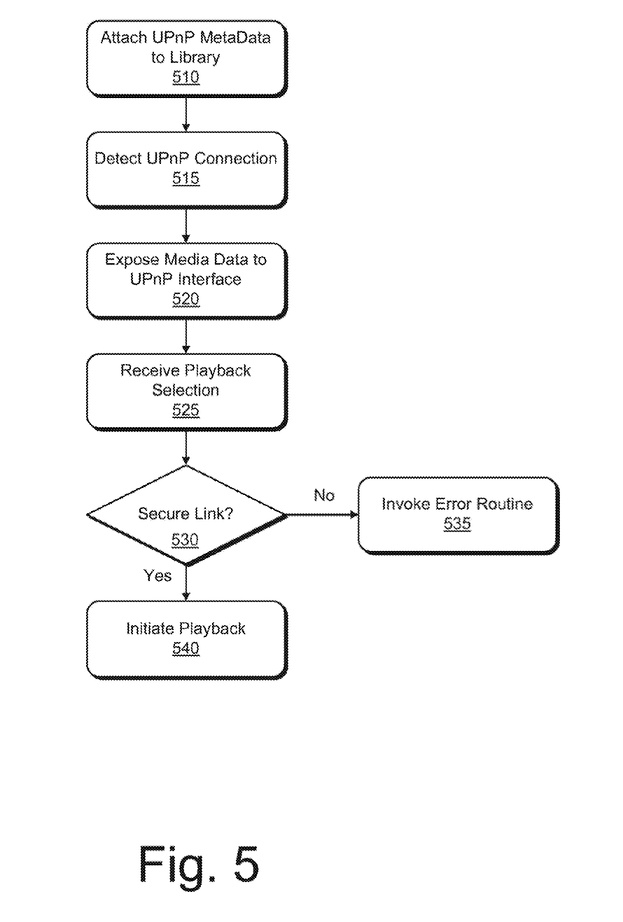

FIG. 5 is a flowchart illustrating operations in one embodiment of a method to implement a secure media system in network attached storage. Referring to FIG. 5, at operation 510 UPnP metadata is attached to the media files in the media library on NAS device 200. At operation 510 a UPnP connection is detected, and at operation 520 data about the media files is exposed to the UPnP interface, such that the metadata is visible to a UPnP device. At operation 525 a playback selection is received from the UPnP device.

If, at operation 530 a secure link cannot be created between the NAS device 200 and the UPnP requesting device, then control passes to operation 535 and an error routine is invoked. In some embodiments, the error routine may include displaying an error message on a user interface coupled to the NAS device, e.g., on one of the client devices 112a-112f. By contrast, if at operation 530 a secure link can be created between the NAS device 200 and the UPnP requesting device, the control passes to operation 540 and the NAS device 200 initiates a playback of the requested media file.

Some embodiments may be provided as computer program products, which may comprise a machine-readable or computer-readable medium having stored thereon instructions used to program a computer (or other electronic devices) to perform a process discussed herein. The machine-readable medium may comprise, but is not limited to, floppy diskettes, hard disk, optical disks, CD-ROMs, magneto-optical disks, ROMs, RAMs, erasable programmable ROMs (EPROMs), electrically erasable EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Reference in the specification to “one embodiment” or “an embodiment” means that a particular feature, structure, or characteristic described in connection with the embodiment is comprised in at least an implementation. The appearances of the phrase “in one embodiment” in various places in the specification are not necessarily all referring to the same embodiment.

What is claimed is:

1. A method to secure media content in a network attached storage device, comprising:
detecting, in the network attached storage device, a connection of a media source to the network attached storage device;
receiving, in the network attached storage device, an activation key associated with the media source;
determining whether the activation key is stored in a computer-readable memory coupled to the network attached storage device, and in response to a determination that the activation key is not stored in a computer-readable memory coupled to the network attached storage device:
associating the activation key with a device identifier for the network attached storage device; and
storing the activation key and the device identifier in the computer-readable memory coupled to the network attached storage device
creating an image of at least a portion of the media content on the media source in a computer-readable memory coupled to the network attached storage device; and
binding the image of the media content to the network attached storage device.

2. The method of claim 1, wherein in response to a determination that the activation key is stored in a computer-readable memory coupled to the network attached storage device:
determining whether the activation key is associated with a device identifier for the network attached storage device; and
generating an error message in response to a determination that the activation key is not associated with a device identifier for the network attached storage device.

3. The method of claim 1, wherein:
detecting, in the network attached storage device, a connection of a media source to the network attached storage device comprises detecting the insertion of a media source into a computing device coupled to the network attached storage device.

4. The method of claim 1, wherein receiving, in the network attached storage device, an activation key associated with the media source comprises:
determining, in a computing device coupled to the network attached storage device, that a media source lacks an activation key; and
in response to the determination, initiating a registration session to obtain an activation key for the media source.

5. The method of claim 1, wherein creating an image of at least a portion of the media content on the media source in a computer-readable memory coupled to the network attached storage device comprises encrypting at least a portion of the media content using the activation key.

6. The method of claim 1, wherein creating an image of at least a portion of the media content on the media source in a computer-readable memory coupled to the network attached storage device comprises encrypting at least a portion of the media content using the a key extracted from a component of the network attached storage device.

7. The method of claim 1, wherein creating an image of at least a portion of the media content on the media source in a computer-readable memory coupled to the network attached storage device comprises creating an ISO image of media content.

8. The method of claim 1, further comprising:
receiving, in the networked attached storage device, a request to playback at least a portion of the media content from the computer-readable memory;
determining, in the networked attached storage device, whether the activation key associated with the at least a portion of the media content is valid; and
in response to a determination that the activation key associated with the at least a portion of the media content is valid, initiating a playback of the at least a portion of the media content.

9. The method of claim 1, further comprising:
receiving, in the networked attached storage device, a request to playback at least a portion of the media content from the computer-readable memory;
determining, in the networked attached storage device, whether the activation key associated with the at least a portion of the media content is valid; and
in response to a determination that the activation key associated with the at least a portion of the media content is invalid:
generating an error message indicating that the activation key is invalid; and
presenting the error message on a user interface.

10. A network attached storage device, comprising:
at least one storage media;
a detection module to detect a connection of a media source to the network attached storage device;
a network interface to receive, in the network attached storage device, an activation key associated with the media source;
an activation module to determine whether the activation key is stored in a computer-readable memory coupled to the network attached storage device, and in response to a determination that the activation key is not stored in a computer-readable memory coupled to the network attached storage device:
to associate the activation key with a device identifier for the network attached storage device; and
to store the activation key and the device identifier in the computer-readable memory coupled to the network attached storage device
an imaging module to create an image of at least a portion of the media content on the media source in a computer-readable memory coupled to the network attached storage device; and
a security module binding the image of the media content to the network attached storage device.

11. The network attached storage device of claim 10, wherein in response to a determination that the activation key is stored in a computer-readable memory coupled to the network attached storage device, the activation module:
determines whether the activation key is associated with a device identifier for the network attached storage device; and
generates an error message in response to a determination that the activation key is not associated with a device identifier for the network attached storage device.

12. The network attached storage device of claim 10, wherein:
the detection module detects the insertion of a media source into a computing device coupled to the network attached storage device.

13. The network attached storage device of claim 10, wherein a computing device coupled to the network attached storage device:
determines that a media source lacks an activation key; and
initiates a registration session to obtain an activation key for the media source.

14. The network attached storage device of claim 10, wherein the imaging module encrypts at least a portion of the media content using the activation key.

15. The network attached storage device of claim 10, wherein the imaging module encrypts at least a portion of the media content using a key extracted from a component of the network attached storage device.

16. The network attached storage device of claim 10, wherein the imaging module creates an ISO image of media content.

17. The network attached storage device of claim 10, further comprising a playback module to:
receive a request to playback at least a portion of the media content from the computer-readable memory;
determine whether the activation key associated with the at least a portion of the media content is valid; and
in response to a determination that the activation key associated with the at least a portion of the media content is valid, initiate a playback of the at least a portion of the media content.

18. The network attached storage device of claim 10, further comprising a playback module to:
receive a request to playback at least a portion of the media content from the computer-readable memory;
determine whether the activation key associated with the at least a portion of the media content is valid; and
in response to a determination that the activation key associated with the at least a portion of the media content is invalid:
generate an error message indicating that the activation key is invalid; and
present the error message on a user interface.
